(19) United States
(12) Patent Application Publication
(10) Pub. No.: US 2005/0272444 A1
(43) Pub. Date: Dec. 8, 2005

(54) Method and system for directing users to coverage

(76) Inventors: Timothy W. Heffield, Sunrise, FL (US); Craig G. Bishop, Boca Raton, FL (US); Kevin M. Eldred, Endicott, NY (US); Jose E. Korneluk, Boynton Beach, FL (US); Vijay V. Ram, Arlington, TX (US); Thomas F. Kung, Fort Worth, TX (US); Victor Nguyen, Fort Worth, TX (US)

Correspondence Address: Larry G. Brown;Motorola, Inc., Law Department, 8000 West Sunrise Boulevard, Fort Lauderdale, FL, 33322, US

(21) Appl. No.: 10/863,143

(22) Filed: Jun. 8, 2004

(51) Int. Cl. H04B 3/36

(52) U.S. Cl. 455/456.2; 455/445

(57) ABSTRACT

The invention concerns a method (300) for directing users to coverage. The method includes the steps of detecting (314) when a signal strength parameter of a mobile unit (112) falls below a predetermined threshold, acquiring (316) positional information about the mobile unit and directing (322) a user of the mobile unit to a reestablishing coverage area (110) that has a signal strength that would cause the signal strength parameter to meet the predetermined threshold. In addition, the method can include the step of calculating (320) positional parameters between the mobile unit and the reestablishing coverage area in which the reestablishing coverage area is a coverage area (110) that is physically closest to the mobile unit in comparison to other coverage areas.

### BACKGROUND OF THE INVENTION

1. Field of the Invention

This invention relates in general to portable electronic devices for facilitating wireless communications and more particularly, to such devices having global positioning system capabilities.

2. Description of the Related Art

Portable electronic devices are ubiquitous in today's society. A large number of these devices rely on communications networks to permit a user of such a device to engage in a conversation or to receive and transmit data. Virtually all large urban areas are well-served by such networks. Notably, however, the range of these networks is limited, and many rural areas have little or no communications reception. As a result, it is common that users of portable electronic devices find themselves in an area that is not served by their wireless carrier.

While some users may be content without having any available service for brief or even extended periods of time, some individuals may need to reestablish communications quickly. As an example, a user who is attempting to conduct important business or financial transactions or who is faced with an emergency may have to urgently reacquire a signal. To do so, however, a user must remember how to traverse back to the area where he had a sufficient signal. Alternatively, the user may walk or drive in an uncoordinated manner until he relocates a cell.

### SUMMARY OF THE INVENTION

The present invention concerns a method of directing a user to coverage. The method includes the steps of detecting when a signal strength parameter of a mobile unit falls below a predetermined threshold, acquiring positional information about the mobile unit and directing a user of the mobile unit to a reestablishing coverage area that has a signal strength that would cause the signal strength parameter to meet the predetermined threshold. In one arrangement, the method can further include the step of calculating positional parameters between the mobile unit and the reestablishing coverage area. As an example, the reestablishing coverage area can be a coverage area that is geographically closest to the mobile unit in comparison to other coverage areas.

In another arrangement, the method can include the steps of repeating the step of acquiring positional information about the mobile unit and modifying the directing step based on new positional information acquired about the mobile unit. The method can also include the step of directing the user of the mobile unit to a new reestablishing coverage area if the new reestablishing coverage area is geographically closer to the previous reestablishing coverage area based on the new positional information acquired about the mobile unit.

In one embodiment of the invention, the acquiring step further includes acquiring positional information about the mobile unit after the detecting step. Also, the invention can include the step of acquiring positional information about at least one of a first coverage area and neighboring coverage areas when the mobile unit enters the first coverage area. Moreover, when the signal strength parameter of the mobile unit falls below the predetermined threshold, the method can include the step of sorting a list that at least includes the first coverage area and the neighboring coverage areas. As an example, the reestablishing coverage area can be at least one of the first coverage area and the neighboring coverage areas. The list can be resorted if it is determined that a new reestablishing coverage area must be used. The new reestablishing coverage area can be at least one of the first coverage area and the neighboring coverage areas.

In another embodiment of the invention, the directing step can further include directing the user of the mobile unit to a reestablishing coverage area that has a signal strength that would cause the signal strength parameter to meet the predetermined threshold by providing directions to the user through a display and/or a speaker. As an option, the method can include the step of displaying a recovery map to provide the directions to the user through at least one of the display and the speaker. In one particular arrangement, the recovery map can be downloaded from a communications network, and the range of the recovery map can depend on the terrain in which the mobile unit is located.

The present invention also concerns a mobile unit for directing users to coverage. The mobile unit includes a processor in which the processor is programmed to detect when a signal strength parameter falls below a predetermined threshold, a global positioning system element in which the global positioning system element acquires positional information about the mobile unit and a user interface. The processor is programmed to receive the positional information from the global positioning system element and to direct a user of the mobile unit through the user interface to a reestablishing coverage area that has a signal strength that would cause the signal strength parameter to meet the predetermined threshold. The mobile unit can also include suitable software and/or circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a portion of a communications network and a mobile unit in accordance with an embodiment of the inventive arrangements;

FIG. 2 illustrates a block diagram of the mobile unit of FIG. 1 in accordance with an embodiment of the inventive arrangements;

FIG. 3 illustrates a portion of a method for directing users to coverage in accordance with an embodiment of the inventive arrangements;

FIG. 4 illustrates another portion of the method of FIG. 3 in accordance with an embodiment of the inventive arrangements;

FIG. 5 illustrates a list of coverage areas and their positional information in accordance with an embodiment of the inventive arrangements;

FIG. 6 illustrates an example of directions on a display in accordance with an embodiment of the inventive arrangements;

FIG. 7 illustrates an example of a recovery map in accordance with an embodiment of the inventive arrangements; and

FIG. 8 illustrates another list of coverage areas and their positional information in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Referring to FIG. 1, at least a portion of a communications network 100 is shown in which the communication network 100 has one or more coverage areas 110. As an example, these coverage areas 110 can be sectored or omni-directional cells for a mobile communications system, which, as is known in the art, can facilitate communications between a mobile unit 112 and any other suitable communications device or network. For purposes of the invention, a coverage area can be defined as any geographic area in which a signal is present for facilitating communications for the mobile unit 112. Additionally, the mobile unit 112 can be any portable electronic device capable of wirelessly transmitting or receiving voice or data.

The coverage areas 110 may be situated in a wide variety of locations, including urban and rural areas. As is known in the art, as the mobile unit 112 enters a coverage area 110, the network equipment (not shown) can provide the mobile unit 112 with information about neighboring coverage areas 110. For example, if the mobile unit 112 is currently located in the coverage area 110 designated with the reference letter A, the network equipment can provide information concerning neighboring coverage areas 110, such as the coverage areas 110 designated by the reference letters B, C, D, E, F and G. Upon receipt, the mobile unit 112 can store the information concerning the neighboring coverage areas 110, and the coverage areas 110 listed above are given priority, at least in this particular example. Information can also be provided about the coverage areas 110 designated by the reference letters Dₓ, Eₓ Fₓ and Gₓ. These coverage areas 110, however, typically may not be given as high a priority as the coverage areas recited above. As appreciated by those of skill in the art, this process described above facilitates the ability of the mobile unit 112 to move from one coverage area 110 to another.

Eventually, a user of the mobile unit 112 may exceed the range or reside outside the range of all coverage areas 110. As such, the mobile unit 112 may not be able to receive a signal that is strong enough to permit the mobile unit 112 to transmit or receive. This concept of losing reception generally occurs when a user of the mobile unit 112 is leaving a populated region and moving into a rural area, although it may happen in other areas. In accordance with an embodiment of the inventive arrangements, the mobile unit 112 can direct the user of the mobile unit 112 to a position that has sufficient signal strength to permit the user to make or receive wireless communications. Examples of this process and a suitable mobile unit 112 will be presented below.

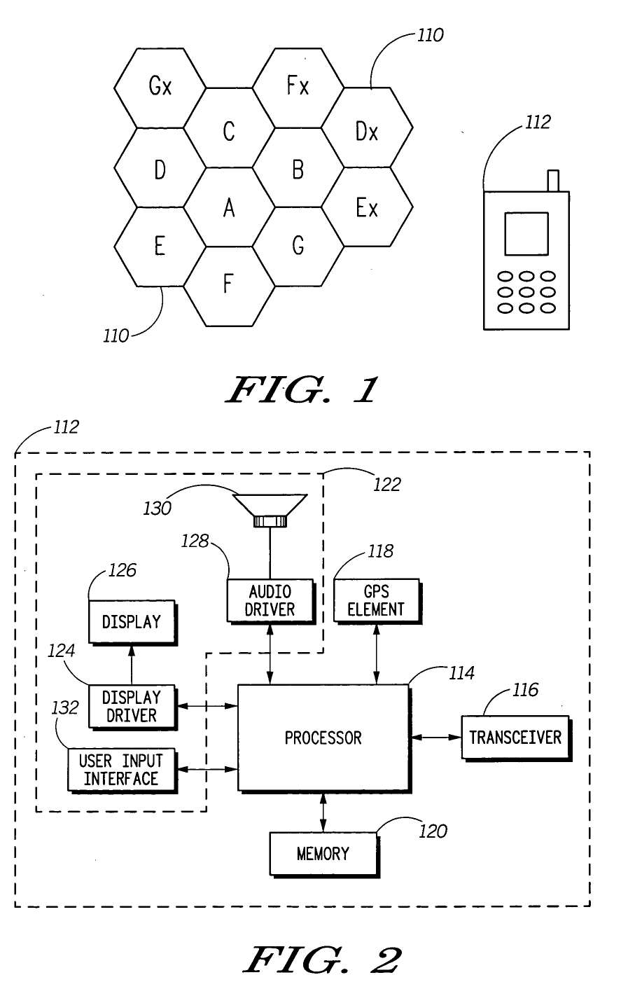

Referring to FIG. 2, a mobile unit 112 for directing users to coverage is shown. In one arrangement, the mobile unit 112 can include a processor 114, a transceiver 116, a global positioning system element 118, a memory 120 and a user interface 122. In another arrangement, the user interface 122 can include a display driver 124, a display 126, an audio driver 128, a speaker 130 and a user input interface 132. Of course, those of ordinary skill in the art will appreciate that the invention is not so limited, as the mobile unit 112 can include a greater number (or even fewer number) of components for its operation.

As is known in the art, the transceiver 116, at the request of the processor 114, can permit the mobile unit 112 to transmit and receive voice or data over a wireless communications network. The memory 120 can be any suitable memory for storing data and executable instructions that the processor 114 can utilize. Moreover, the GPS element 118 can acquire positional information about the mobile unit 112 and can provide this information to the processor 114. The GPS element 118 can be any suitable combination of discrete and/or integrated components and software useful for determining positional information about the mobile unit 112 using any suitable technique. For example, the GPS element 118, as is also known in the art, can determine the latitude and longitude of the mobile unit 112.

The display driver 124 can be used to cause images to be displayed on the display 126, examples of which will be described later. Similarly, the audio driver 128 can be used to cause sound to be broadcast from the speaker 130. The user input interface 132 can receive input from a user of the mobile unit 112 and can transmit this input to the processor 114. As an example, the user input interface 132 can be a keypad, buttons, a microphone or any other component that a user can use to provide input to the mobile unit 112.

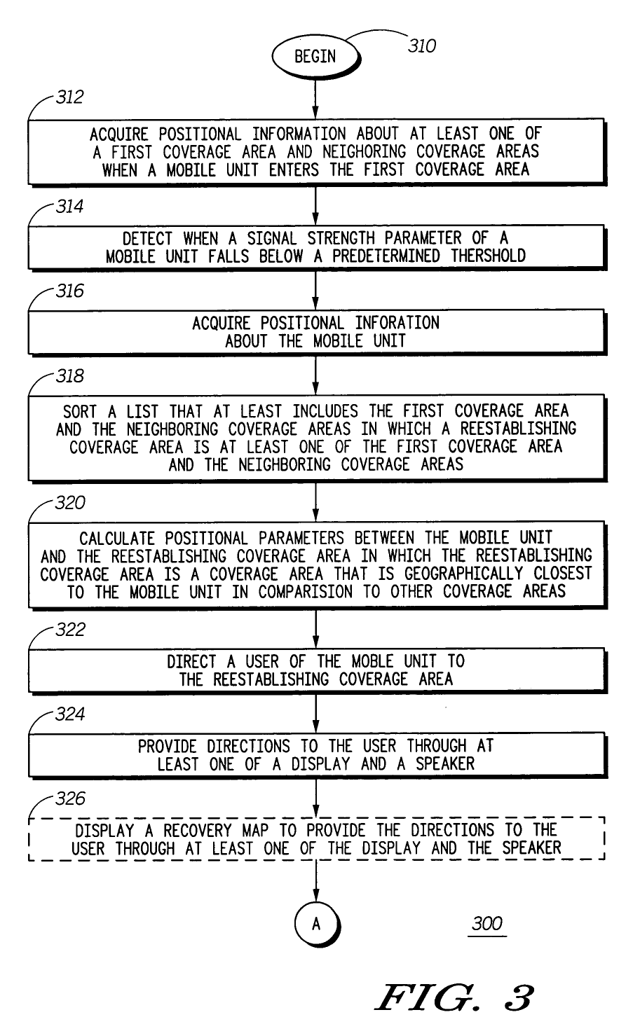

Referring to FIG. 3, a method 300 for directing users to coverage is shown. To describe the method 300, reference will be made to FIGS. 1 and 2, although it is understood that the method 300 can be practiced with any other suitable communications network and mobile unit. Moreover, the steps of method 300 are not limited to being practiced in any particular order, and not all the steps are required to implement the invention. At step 310, the method 300 can begin. At step 312, positional information about at least one of a first coverage area and neighboring coverage areas can be acquired when a mobile unit enters the first coverage area.

For example, referring back to FIGS. 1 and 2, the mobile unit 112 can enter one of the coverage areas 110 of the communications network 100. As an even more specific example, the mobile unit 112 can enter the coverage area 110 designated by the reference letter G. In this example, the G coverage area 110 can be referred to as the first coverage area 110. When this event occurs, the network equipment in the G coverage area 110 can provide information to the mobile unit 112 about the G coverage area 110 and its neighboring coverage areas 110, such as those coverage areas designated by the reference letters Eₓ, B, A, F, E, D, C and Fₓ. In one arrangement, at least part of the information received by the mobile unit 112 can include positional information about the G, Eₓ, B, A, F, E, D, C and Fₓ coverage areas 110.

This positional information can be the latitudinal and longitudinal coordinates of, for example, the base station that serves a particular coverage area 110. This positional information can also include the range of the coverage area 110. It is understood, however, that the positional information can be any other information suitable for determining the location of a coverage area 110 and its suitability for enabling a mobile unit 112 to reacquire a signal. In another arrangement, this positional information can be broadcast to the mobile unit 112 over an auxiliary channel, such as a Broadcast Common Control Channel (BCCH), although the information can be broadcast to the mobile unit 112 over any other suitable channel. The processor 114 of the mobile unit 112 can receive the positional information from the transceiver 116, and in response, the processor 114 can transfer this information to the memory 120.

Referring back to the method 300 of FIG. 3, at step 314, the occurrence of a signal strength parameter falling below a predetermined threshold can be detected. Further, positional information can be acquired about the mobile unit, as shown at step 316. For example and referring once again to FIGS. 1 and 2, the mobile unit 112 may eventually leave the G coverage area 110 and move into an area that has no signal reception. When this event occurs, the processor 114, as is known in the art, can detect that the parameter that measures signal strength has dropped below a predetermined threshold. As an example, this predetermined threshold can be the minimum level of reception need to enable the mobile unit 112 to perform communications functions, such as transmitting and receiving voice or data. It must be noted that the total loss of a signal is considered to be an occurrence of a signal strength parameter falling below a predetermined threshold.

The GPS element 118 of the mobile unit 112 can acquire positional information about the mobile unit 112. As an example, the positional information can be the latitudinal and longitudinal coordinates of the mobile unit 112, although the positional information can be any other suitable data for determining the geographic location of the mobile unit 112. In one embodiment of the invention, the processor 114 can instruct the GPS element 118 to acquire the positional information about the mobile unit 112 after the processor 114 detects that the signal strength parameter has dropped below the predetermined threshold. In another arrangement, the processor 114 can instruct the GPS element 118 to acquire the positional information after the detecting step described above but only after a user of the mobile unit 112 attempts to perform some function through the user input interface 132, such as pressing a keypad button. In still yet another alternative, the GPS element 118 can continuously acquire positional information about the mobile unit 112, even before a user of the mobile unit 112 ventures into an area with no signal coverage.

Referring back to the method 300 of FIG. 3, at step 318, a list that at least includes the first coverage area and the neighboring coverage areas can be sorted in which a reestablishing coverage area is at least one of the first coverage area and the neighboring coverage areas. At step 320, positional parameters between the mobile unit and the reestablishing coverage area can be calculated in which the reestablishing coverage area is a coverage area that is geographically closest to the mobile unit in comparison to other coverage areas.

For example, referring back to FIGS. 1 and 2, the processor 114 can sort the coverage areas 110 based on their positional information that the processor 114 previously received. In one particular embodiment, the processor 114 can sort the coverage areas 110 based on their proximity to the positional information that the processor 114 has received from the GPS element 118. As such, the processor 114 can generate a list in which the coverage areas 110 that are geographically closer to the mobile unit 112 are given priority; those coverage areas that are farther away may be given lower priority. The list can be stored in the memory 120.

The phrases “geographically closer coverage area” or “geographically closest coverage area” can refer to a coverage area 110 that has a range that is physically closest to the mobile unit 112 in comparison to the other coverage areas 110. Additionally, these phrases can also refer to the coverage area 110 that has latitudinal or longitudinal coordinates that are physically closest to the mobile unit 112 in comparison to other coverage areas 110. Although a coverage area 110 may have latitudinal and longitudinal coordinates that are closer to the mobile unit 112, another coverage area 110 may be geographically closest to the mobile unit 112 because its range is closer to the mobile unit 112 than that of the coverage area 110 with the closer coordinates.

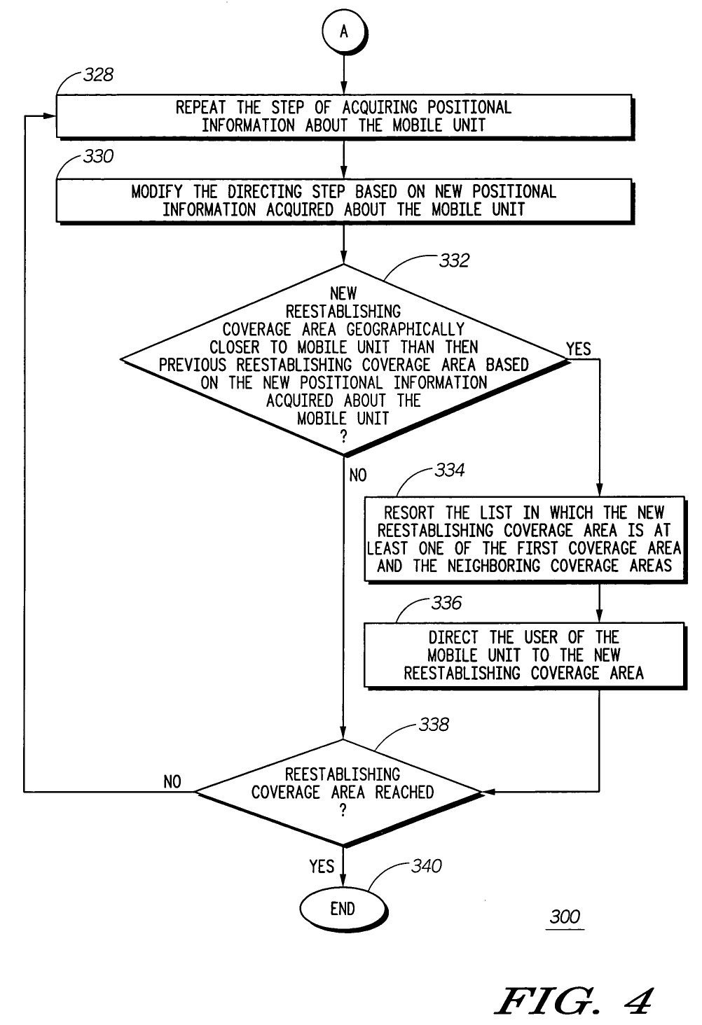

As an example, if the user of the mobile unit 112 leaves the lower part of the G coverage area 110 and moves into a location with no coverage, the processor 114 can sort a list that includes the G coverage area 110 and its neighboring coverage areas 110. An example of such a list is shown in FIG. 5. In FIG. 5 (and still referring to FIGS. 1 and 2), a list 400 is shown in which the G coverage area 110 is listed first, followed by the neighboring coverage areas 110 designated by the reference letters F, A, Eₓ, B, E, and Dₓ.

The positioning of a coverage area 110 on the list 400 can correspond to the geographic proximity that the coverage area 110 has with the mobile unit 112. Thus, those coverage areas 110 near the lower part of the list 400 can be farther away from the mobile unit 112 than those listed near the top. As also shown in FIG. 5, the positional information associated with each listed coverage area 110 may be included in the list 400. This list 400 may be dynamic, an example of which will be illustrated below. It should also be noted that those of skill in the art will appreciate that the entries in any list that the processor 114 sorts can be used to update a learned bandmap list to enable the operation of a rapid service recovery algorithm when the mobile unit 112 reacquires a communications signal.

In addition, more than one list 400 may be sorted during this process, each having coverage areas 110 arranged according to their proximity to the mobile unit 112. The first coverage area 110, however, can be different for each of the lists 400. For example, a list 400 can be sorted in which the F coverage area 110 is listed first, followed by neighboring coverage areas 110 being listed based on proximity. As will be explained later, this process can be useful if the user of the mobile unit 112, while in the area with no reception, moves closer to a coverage area 110 that is different from the one that the user initially left.

In one arrangement of the invention, one of the coverage areas 110 can be referred to as a reestablishing coverage area 110. A reestablishing coverage area 110 can be the coverage area 110 intended to provide the mobile unit 112 with a signal strong enough to cause the signal strength parameter to at least meet the predetermined threshold mentioned above. As an example, the reestablishing coverage area 110 can be either the first coverage area 110 (G coverage area 110, in this example) or a neighboring coverage area 110 (F, A, Eₓ, B, E, and Dₓ, in this example). As noted earlier, the reestablishing coverage area 110 can be the coverage area 110 that is geographically closest to the mobile unit 112 in comparison to other coverage areas 110. In this example, the G coverage area 110 can be the reestablishing coverage area 110 because its range and latitude and longitude coordinates are closer to the mobile unit 112 than those of the other coverage areas 110 (those designated by the reference letters F, A, Eₓ, B, E, and Dₓ). It is understood, however, that the invention is not so limited, as any other suitable coverage area 110 can serve as the reestablishing coverage area 110.

The processor 114 can then calculate positional parameters between the mobile unit 112 and the reestablishing coverage area 110. For example, the positional parameters can be a distance from the mobile unit 112 to the reestablishing coverage area 110 and a corresponding direction or bearing. This distance can be measured from, for example, the outside range of the coverage area 110, the center of the coverage area 110 or any other suitable point inside the coverage area 110. It is understood, however, that other suitable parameters, in addition to or in lieu of the above examples, can be calculated during this process.

It must be noted that it is not necessary to obtain positional information about neighboring coverage areas 110 and to construct or sort a list in which the reestablishing coverage area 110 is listed first followed by suitable neighboring coverage areas 110. In particular, the mobile unit 112 can acquire positional information about the current coverage area 110 in which it is situated. If the mobile unit 112 moves out of the range of the coverage area 110, then merely this previous coverage area 110 can serve as the reestablishing coverage area 110.

Referring back to FIG. 3, at step 322, a user of the mobile unit can be directed to the reestablishing coverage area. As shown at step 324, providing directions to the user through at least one of a display and a speaker can be one way a user of the mobile unit is directed to the reestablishing coverage area. As an optional step, a recovery map can be displayed to provide the directions to the user through at least one of the display and the speaker, as shown at step 326.

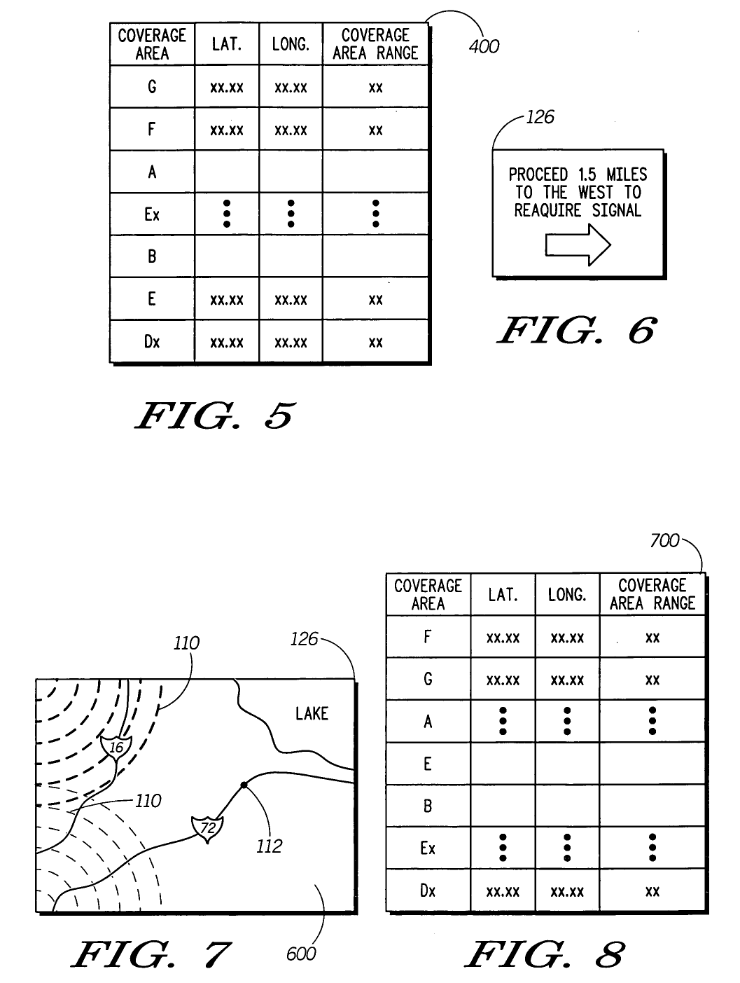

In one arrangement and referring once again to FIGS. 1 and 2, the processor 114 can provide directions to the user of the mobile unit 112 through the display 126 or the speaker 130. As an example, the directions can be displayed on the display 126 in the form of text, and these directions can also be broadcast over the speaker 130. For example, the distance to the reestablishing coverage area 110 and the general direction towards the reestablishing coverage area 110 can be displayed or broadcast. In addition, an arrow or some other guiding symbol can be provided with the displayed text to guide the user of the mobile unit 112 in the proper direction. An example is shown in FIG. 6 in which the display 126 is displaying directions.

Alternatively, the processor 114 can cause a recovery map to be displayed on the display 126. An example of a recovery map 600 is shown in FIG. 7. In one arrangement, the recovery map 600 can show the positioning of the mobile unit 112 and one or more coverage areas 110, any one of which can be the reestablishing coverage area 110. These coverage areas 110 can be indicated by the dashed, circular lines on the recovery map 600. The recovery map 600 can also show referencing landmarks, such as roads and waterways. The user of the mobile unit 112 can use the recovery map 600 to determine which way he should progress to reacquire a communications signal. In one arrangement, the recovery map 600 can be downloaded to the mobile unit 112 from the network equipment of a coverage area 110 when the mobile unit 112 is in that particular coverage area 110. Alternatively, the recovery map 600 can already be present in the mobile unit 112 by being stored in the memory 120 of the mobile unit 112 at some earlier time.

In one arrangement, the range of the recovery map 600 can be determined based on the type of terrain in which the coverage area 110 or the mobile unit 112 is located. That is, if a communications network is providing a recovery map 600 to the mobile unit 112, the range of this recovery map 600 can be based on the terrain in which the coverage area 110 is situated. Similarly, if the mobile unit 112 is accessing a recovery map 600 from its own memory 120, the range of this recovery map 600 can be based on the terrain in which the mobile unit 112 currently resides.

For example, if the terrain in which the coverage area 110 or the mobile unit 112 resides is primarily an urban setting, the range of the recovery map 600 can be kept to a relatively lower value because the chances of quickly finding a reestablishing coverage area 110 are higher. Conversely, if the terrain in which the coverage area 110 sits is primarily rural, the range of the recovery map 600 can be higher because the number of possible reestablishing coverage areas 110 may be lower. If no information is available concerning the type of terrain in which the mobile unit 112 or the coverage area 110 sits, a default range can be selected, e.g., a range of fifty miles.

Referring back to the method 300, in FIG. 4, through jump circle A (also from FIG. 3), at step 328, the step of acquiring positional information about the mobile unit can be repeated. At step 330, the directing step can be modified based on new positional information acquired about the mobile unit. For example, referring back to FIGS. 1 and 2, the GPS element 118 can periodically obtain positional information about the mobile unit 112 and can forward the positional information to the processor 114. The positional information may change, particularly in view of the user of the mobile unit 112 moving towards the reestablishing coverage area 110.

In view of any new positional information that it receives, the processor 114 can modify or update the instructions or directions that it is currently providing to the user of the mobile unit 112. For example, the distance between the mobile unit 112 and the reestablishing coverage area 110 may have decreased. As a result, the processor 114 can cause the updated distance to be displayed on the display 126 and/or broadcast on the speaker 130. In addition, the processor 114 can also cause to be displayed and/or broadcast a change in the direction or bearing that the user may take to reach the reestablishing coverage area 110. Additionally, if a recovery map 600 (see FIG. 7) is being used, the positioning of the mobile unit 112 in relation to the reestablishing coverage area 110 can be updated.

There may be certain instances where the user of the mobile unit 112 may move in such a manner that another coverage area 110 may become closer to the mobile unit 112 than the initial reestablishing coverage area 110. Again, a coverage area 110 becoming closer can mean, for example, the range or latitude/longitude coordinates of the coverage area 110 becoming closer to the mobile unit 112. Referring back to the method 300 of FIG. 4, at decision block 332, it can be determined whether a new reestablishing coverage area is present in which the new reestablishing coverage area is geographically closer to the mobile unit than the previous reestablishing coverage area. This determination can be based on the new positional information acquired about the mobile unit. If no, the method 300 can resume at step 338. If yes, at step 334, the list can be resorted in which the new reestablishing coverage area can be at least one of the first coverage area and the neighboring coverage areas. In addition, at step 336, the user of the mobile unit can be directed to the new reestablishing coverage area.

For example, referring once again to FIGS. 1 and 2, the user of the mobile unit 112 may move closer to a coverage area 110 that is actually closer than the current reestablishing coverage area 110. In reference to the example described earlier, the mobile unit 112 may eventually move closer to the F coverage area 110 than the G coverage area 110 (the initial reestablishing coverage area 110). Accordingly, the F coverage area 110 can become the new reestablishing coverage area 110.

The processor 114 can resort the list to indicate the change, an example of which is shown in FIG. 8. In FIG. 8, the F coverage area 110 is shown as the new reestablishing coverage area 110 in a list 700 and the neighboring coverage areas 110 are listed in descending order based on their updated proximity to the mobile unit 112. In another arrangement, the phrase “resort the list” can actually include fetching a previously generated list 700 from the memory 120. That is, if the processor 114 previously sorts several lists 700 in step 318 (see FIG. 3), which was alluded to earlier, one of these lists 700 can be accessed based on the new positional information. The processor 114, in accordance with the above discussion, can cause new directions to be displayed or broadcast to the user of the mobile unit 112 in an effort to direct the user to the new reestablishing coverage area 110.

It is understood, however, that this process of updating the reestablishing coverage area 110 is not necessary to practice the invention. Specifically, if desired, the initial reestablishing coverage area 110 can remain the reestablishing coverage area 110, even if the user moves closer to another coverage area 110.

Referring back to the method 300 of FIG. 4, at decision block 338, it can be determined whether the reestablishing coverage area has been reached. This reestablishing coverage area can be the initial reestablishing coverage area or any new establishing coverage areas. If yes, the method 300 can end at step 340. If no, the method 300 can resume at step 328, where the process of directing the user of the mobile unit towards a reestablishing coverage area can continue. In one arrangement, referring to FIGS. 1 and 2, if the user of the mobile unit 112 has reached the reestablishing coverage area 110, the processor 114 can detect that the signal strength parameter has reached the predetermined threshold. As a result, the mobile unit 112 can once again facilitate communications. As an option, the processor 114 can instruct the GPS element 118 to shut down to conserve battery life.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for directing a user to coverage, comprising the steps of:
detecting when a signal strength parameter of a mobile unit falls below a predetermined threshold;
acquiring positional information about the mobile unit; and
directing a user of the mobile unit to a reestablishing coverage area that has a signal strength that would cause the signal strength parameter to meet the predetermined threshold.

2. The method according to claim 1, further comprising the step of calculating positional parameters between the mobile unit and the reestablishing coverage area and wherein the reestablishing coverage area is a coverage area that is geographically closest to the mobile unit in comparison to other coverage areas.

3. The method according to claim 1, further comprising the steps of:
repeating the step of acquiring positional information about the mobile unit;
modifying the directing step based on new positional information acquired about the mobile unit.

4. The method according to claim 3, further comprising the step of directing the user of the mobile unit to a new reestablishing coverage area if the new reestablishing coverage area is geographically closer than the previous reestablishing coverage area based on the new positional information acquired about the mobile unit.

5. The method according to claim 1, wherein the acquiring step further comprises acquiring positional information about the mobile unit after the detecting step.

6. The method according to claim 1, further comprising the step of acquiring positional information about at least one of a first coverage area and neighboring coverage areas when the mobile unit enters the first coverage area.

7. The method according to claim 6, further comprising the step of, when the signal strength parameter of the mobile unit falls below the predetermined threshold, sorting a list that at least includes the first coverage area and the neighboring coverage areas, wherein the reestablishing coverage area is at least one of the first coverage area and the neighboring coverage areas.

8. The method according to claim 7, further comprising the step of resorting the list if it is determined that a new reestablishing coverage area must be used, wherein the new reestablishing coverage area is at least one of the first coverage area and the neighboring coverage areas.

9. The method according to claim 1, wherein the directing step further comprises directing the user of the mobile unit to a reestablishing coverage area that has a signal strength that would cause the signal strength parameter to meet the predetermined threshold by providing directions to the user through at least one of a display and a speaker.

10. The method according to claim 9, further comprising the step of displaying a recovery map to provide the directions to the user through at least one of the display and the speaker.

11. The method according to claim 10, wherein the recovery map is downloaded from a communications network and wherein the range of the recovery map depends on the terrain in which the mobile unit is located.

12. A mobile unit for directing users to coverage, comprising:
a processor, wherein the processor is programmed to detect when a signal strength parameter falls below a predetermined threshold;
a global positioning system element, wherein the global positioning system element acquires positional information about the mobile unit; and
a user interface, wherein the processor is programmed to receive the positional information from the global positioning system element and to direct a user of the mobile unit through the user interface to a reestablishing coverage area that has a signal strength that would cause the signal strength parameter to meet the predetermined threshold.

13. The mobile unit according to claim 12, wherein the processor is further programmed to calculate positional parameters between the mobile unit and the reestablishing coverage area and wherein the reestablishing coverage area is a coverage area that is geographically closest to the mobile unit in comparison to other coverage areas.

14. The mobile unit according to claim 12, wherein the global positioning system element repeatedly acquires the positional information about the mobile unit and the processor is further programmed to redirect the user of the mobile unit based on new positional information acquired about the mobile unit.

15. The method according to claim 14, wherein the processor is further programmed to direct the user of the mobile unit to a new reestablishing coverage area if the new reestablishing coverage area is geographically closer than the previous reestablishing coverage area based on the new positional information acquired about the mobile unit.

16. The mobile unit according to claim 12, wherein the global positioning system element acquires positional information about the mobile unit after the processor detects the signal strength parameter falling below the predetermined threshold.

17. The mobile unit according to claim 12, wherein the processor is further programmed to acquire positional information about at least one of a first coverage area and neighboring coverage areas when the mobile unit enters the first coverage area.

18. The mobile unit according to claim 17, wherein when the processor detects that the signal strength parameter of the mobile unit has fallen below the predetermined threshold, the processor is further programmed to sort a list that at least includes the first coverage area and the neighboring coverage areas, wherein the reestablishing coverage area is at least one of the first coverage area and the neighboring coverage areas.

19. The mobile unit according to claim 18, wherein the processor is further programmed to resort the list if the processor determines that a new reestablishing coverage area must be used, wherein the new reestablishing coverage area is at least one of the first coverage area and the neighboring coverage areas.

20. The mobile unit according to claim 12, wherein the user interface is at least one of a display and a speaker and the processor is further programmed to direct the user of the mobile unit to the reestablishing coverage area by providing directions to the user through at least one of the display and the speaker.

21. The mobile unit according to claim 20, wherein the processor is further programmed to cause a recovery map to be displayed on the display to provide directions to the user.

22. The mobile unit according to claim 21, wherein the mobile unit receives the recovery map from a communications network and wherein the range of the recovery map depends on the terrain in which the mobile unit is located.
